(19) United States
(12) Patent Application Publication
(10) Pub. No.: US 2008/0199092 A1
(43) Pub. Date: Aug. 21, 2008

(54) Image Data Generating Method, Apparatus Thereof, Image Distributing System, Image Distributing Apparatus Thereof, and Their Programs

(76) Inventors: Kazuo Ishida, Tokyo (JP); Jun Takada, Tokyo (JP)

Correspondence Address: FOLEY AND LARDNER LLP;SUITE 500, 3000 K STREET NW, WASHINGTON, DC, 20007, US

(21) Appl. No.: 11/793,337

(22) PCT Filed: Dec. 19, 2005
(86) PCT No.: PCT/JP2005/023234

§ 371 Date: Jun. 19, 2007

(30) Foreign Application Priority Data
Dec. 20, 2004 (JP) 2004-367137

(51) Int. Cl. G06K 9/36

(52) U.S. Cl. 382/246

(57) ABSTRACT

There are included an image data storing means for accumulating image data of JPEG format; an image dividing means for dividing the accumulated JPEG images; and a distributing means for distributing the divided image data to a client. The image dividing means decides a title area containing an image area required for display at the client, and extracts coefficient data, which corresponds to the title area, from the image data accumulated in the image data storing means. The image dividing means then calculates, as coefficient data to be distributed to the client, the values of AC components of the extracted coefficient data as they are but, as to DC components thereof, a result of addition of the values of the DC components to those in the adjacent, immediately preceding title area. The distributing means distributes, as the image data, the coefficient data as calculated to the client.

### TECHNICAL FIELD

The present invention relates to an image data generating method, an apparatus thereof, an image distributing system, an image distributing apparatus thereof, and their programs, and particularly, to a technology for efficiently dividing an image to achieve reduction of the amount of resources needed to decode image data in an area required for display.

### BACKGROUND ART

A system for distributing a page image of a document stored in a server to a client for display and review has been contemplated. However, if the size of a display screen of the client is small as in that of a cell phone, only a partial area of the page image distributed by the server can be displayed at a time, which poses a problem that it takes an extra time for a user of the client to acquire a portion of the page image that is not displayed.

To solve such a problem, there is proposed a technique in which a partial-area image fitted to the size of a display screen of a client that has made a request for distribution of a page image is clipped out of the page image for distribution (see Patent Document 1, for example).

The invention described in Patent Document 1 is for producing a partial-area image selected from a page image that contains a plurality of macro blocks of image data, wherein in producing the partial-area image, part of the DC component values are recalculated and incorporated in re-sort of a group of pixels in the partial-area image. In particular, a DC component of each of macro blocks contained in a partial area is recalculated to obtain a difference value from that of a preceding macro block so that the selected portion is produced as one JPEG image as a whole.

Moreover, to solve the aforementioned problem, a standard image format such as Flashpix or JPEG 2000 is intended to divide one frame of image data into a plurality of sub-areas called tiles beforehand and perform encoding tile by tile, and thus, it is possible to distribute only partial-area image data corresponding to the request for distribution from the client, rather than the entire image data.

PATENT DOCUMENT 1: Japanese Patent Application Laid Open No. 2000-32460

### DISCLOSURE OF THE INVENTION

### PROBLEMS TO BE SOLVED BY THE INVENTION

In the invention described in Patent Document 1, however, when recalculating a DC component, a difference value from that of a preceding macro block is used as a new DC component to produce the entire selected portion as one JPEG image, thus requiring insertion of a restart header. That is, it poses a problem that the size of an image to be produced is increased, and a processing time is lengthened because whether or not the restart header is to be inserted should be decided.

Moreover, a standard image format such as Flashpix or JPEG2000 is capable of performing encoding tile by tile and allows a partial-area image to be distributed to a client without a server clipping and re-encoding the image; however, such image formats are not widespread yet and particularly, they cannot be selected as an output format in most digital cameras or cannot be displayed on most cell phones, thus posing a problem that a usage pattern such as storing a photograph taken by a digital camera in a server and reviewing it on a cell phone, for example, cannot be easily realized.

The present invention has been made in view of such problems, and is to provide a technology that employs an image format usable in currently prevalent digital cameras or cell phones, and is capable of reducing a load of processing of generating data for a partial-area image fitted to the size of a display screen of a client.

### MEANS TO SOLVE THE PROBLEM

The first invention for solving the above-mentioned problem, is an image data generating method for generating image data for a predetermined image area of an original image, characterized in comprising: selecting tiles corresponding to the predetermined image area from image data of the original image; and generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

The second invention for solving the above-mentioned problem, in the above-mentioned first invention, is characterized in that: the image has image data in a JPEG format.

The third invention for solving the above-mentioned problem, in the above-mentioned first or second invention, is characterized in that: said generated coefficient data for each tile is appended with JPEG header information.

The fourth invention for solving the above-mentioned problem, is an image distributing method for, in response to a request for distribution of image data for a predetermined image area of an original image, distributing the image data of said predetermined image area, characterized in comprising: selecting tiles corresponding to the image area requested for distribution from image data of the original image; generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and transmitting said generated coefficient data for each tile appended with JPEG header information, to the requestor of distribution.

The fifth invention for solving the above-mentioned problem, is an image distributing method for, in response to a request for distribution of image data for a predetermined image area of an original image, distributing the image data of said predetermined image area, characterized in comprising: selecting tiles corresponding to the image area requested for distribution from image data of the original image; generating, as coefficient data for each of the selected tiles, coefficient data whose DC component is a sum of a value of a DC component of the current tile and that of an immediately preceding tile adjacent to said tile in the original image and whose AC component is a value of an AC component in the original image; distributing said generated coefficient data for each tile and JPEG header information separately; and joining said JPEG header information and said coefficient data for each tile at a distributee to generate image data in a JPEG format.

The sixth invention for solving the above-mentioned problem, is an image data generating apparatus for generating image data for a predetermined image area of an original image, characterized in having: means for selecting tiles corresponding to the predetermined image area from image data of the original image; and means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

The seventh invention for solving the above-mentioned problem, in the above-mentioned sixth invention, is characterized in that: the image has image data in a JPEG format.

The eighth invention for solving the above-mentioned problem, is an image distributing apparatus for, in response to a request for distribution of image data for a predetermined image area of an original image, distributing the image data of said predetermined image area, characterized in having: means for selecting tiles corresponding to the image area requested for distribution from image data of the original image; means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and means for transmitting said generated coefficient data for each tile appended with JPEG header information, to the requester of distribution.

The ninth invention for solving the above-mentioned problem, is an image distributing apparatus for, in response to a request for distribution of image data for a predetermined image area of an original image, distributing the image data of said predetermined image area, characterized in having: means for selecting tiles corresponding to the image area requested for distribution from image data of the original image; means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and means for transmitting said generated coefficient data for each tile and JPEG header information separately to the requester of distribution.

The tenth invention for solving the above-mentioned problem, is a program for an image data generating apparatus for generating image data for a predetermined image area of an original image, said program characterized in causing said image data generating apparatus to function as: means for selecting tiles corresponding to the predetermined image area from image data of the original image; and means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

The eleventh invention for solving the above-mentioned problem, in the above-mentioned tenth invention, is characterized in that: the image has image data in a JPEG format.

The twelfth invention for solving the above-mentioned problem, is a program for an image distributing apparatus for, in response to a request for distribution of image data for a predetermined image area of an original image, distributing the image data of said predetermined image area, said program characterized in causing said image distributing apparatus to function as: means for selecting tiles corresponding to the image area requested for distribution from image data of the original image; means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and means for transmitting said generated coefficient data appended with JPEG header information, to the requester of distribution.

The thirteenth invention for solving the above-mentioned problem, is a program for an image distributing apparatus for, in response to a request for distribution of image data for a predetermined image area of an original image, distributing the image data of said predetermined image area, said program characterized in causing said image distributing apparatus to function as:
means for selecting tiles corresponding to the image area requested for distribution from image data of the original image; means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and means for transmitting said generated coefficient data and JPEG header information separately to the requestor of distribution.

The present invention determines a tile area containing a portion to be clipped out of a predetermined original image 400. As used herein, the term tile refers to a divided area obtained by partitioning image data by a predetermined number of pixels. FIG. 2 shows tiles for image data of FIG. 1 and a tile area 501 containing an image area 401.

Next, coefficient data corresponding to the tile area 501 is picked out of the image data of the original image 400 using a known technique. Particularly, JPEG header information of the image data of the original image 400 is analyzed to extract a Huffman table. Then, Huffman-encoded code data in the image data of the original image 400 is extract to derive code data before Huffman-encoding using the Huffman table.

Finally, coefficient data corresponding to each of the tiles present in the tile area 501 is extracted from the code data. The coefficient data for each tile is comprised of a plurality of matrices, an example of which is shown in FIG. 3, containing four Y matrices, one Cb matrix, and one Cr matrix.

At this point, recalculation of a DC component is performed on each matrix of the coefficient data for each tile. First, a DC component of a coefficient for a first tile in the image data is picked out, a DC component of a coefficient for a next tile adjacent to the first tile is then picked out, and the value of the DC component of the coefficient for the first tile and that for the next tile are added together. The resulting sum is used as a DC component of a new coefficient for the next tile adjacent to the first tile, i.e., the tile whose DC component is, being newly recalculated.

Thereafter, the aforementioned calculation is repeated in a similar way until the last one of the target tiles is reached. Such calculation processing is performed for each of matrices contained in the coefficient data.

Moreover, Huffman encoding is performed on a combination of a calculated DC component value and corresponding AC components of the coefficient data using the extracted Huffman table according to a known technique.

The aforementioned processing is performed on coefficient data of all tiles contained in the tile area 501 to obtain Huffman-encoded data.

Image data of the image area 401 is thus obtained.

### EFFECTS OF THE INVENTION

The present invention has an excellent effect that a partial-area image fitted to a displayed image size of a client can be produced without re-encoding the image at a distributor. This is because clipping of a tile area is achieved only by an arithmetic operation on coefficient data.

Moreover, the present invention has an excellent effect that it can be easily applied to currently prevalent digital cameras or cell phones. This is because the invention is configured to operate with image data in a JPEG format that can be used in currently prevalent digital cameras or cell phones.

Furthermore, since according to the present invention, after recalculating coefficient data, the data is distributed as JPEG data appended with a header for each tile, processing such as insertion of a restart header is unnecessary, unlike the known technique.

In addition, the present invention may also have an effect that a connect time can be reduced because the amount of data to be distributed can be reduced by, instead of appending a header to each block, sending common header information to a distributor and generating image data from coefficient data for each tile using the header information.

### BRIEF DESCRIPTION OF THE DRAWINGS

FIG. 1 is a diagram showing an example of image data for explaining the present invention.

FIG. 2 is a diagram showing an example of tiles and a tile area of image data.

FIG. 3 is a diagram showing an example of extracted coefficient data.

FIG. 4 is a diagram showing an example of a procedure of recalculating a DC component of coefficient data.

FIG. 5 is a diagram showing an example of a result of recalculation of coefficient data.

FIG. 6 is a diagram showing an example of JPEG header information.

FIG. 7 is a block diagram showing a configuration of an Embodiment 1 of the present invention.

FIG. 8 shows an example of a format of a request for distribution issued by a client 104.

FIG. 9 is a flow chart showing an operation for extracting coefficient data.

FIG. 10 is a diagram showing an example of a partial-area image distributed to a client.

FIG. 11 is a flow chart of a distribution operation of an Embodiment 2 of the present invention.

FIG. 12 is a flow chart of a distribution operation of the Embodiment 2 of the present invention.

FIG. 13 shows an example of a format of a request for distribution issued by the client 104.

FIG. 14 is a diagram showing an example of a difference when scrolling an image for display.

### EXPLANATION OF SYMBOLS

100 Data processing apparatus
101 Image data storage means
101a Image data
102 Distributing means
103 Image dividing means
104 Client

### BEST MODES FOR CARRYING OUT THE INVENTION

Now embodiments of the present invention will be described.

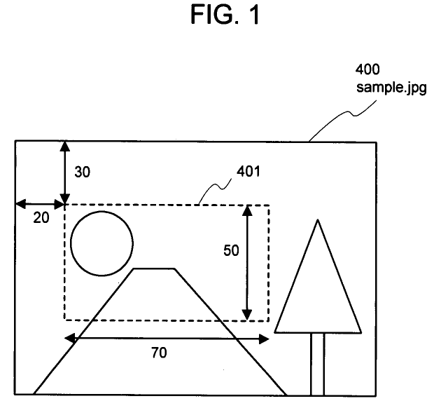

The present invention is an invention for generating image data of a predetermined image area 401 from an original image 400 as shown in FIG. 1. It should be noted that the following description will address an image area 401 having 70 by 50 pixels.

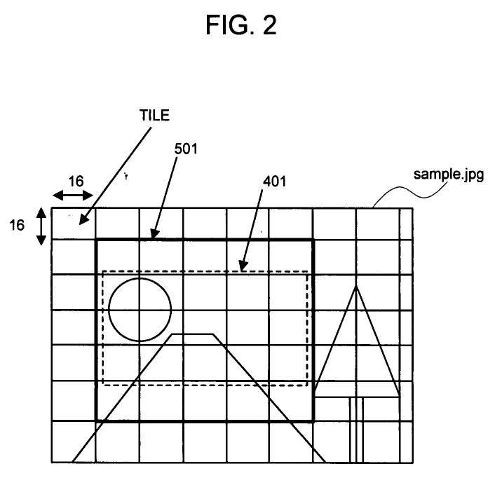

First, according to the present invention, a tile area containing the predetermined image area 401 is determined. As used herein, the term tile refers to a divided area obtained by partitioning image data of the original image 400 by 8m×8n pixels (where m, n designate a set of positive numbers defined by a JPEG standard; they are parameters determined in encoding image data in a JPEG format). FIG. 2 shows tiles for the image data of FIG. 1 (where the image of FIG. 1 is encoded with m=2 and n=2, for example) and a tile area 501 containing the image area 401.

Next, coefficient data corresponding to the tile area 501 is picked out of the image data of the original image 400 using a known technique. Particularly, JPEG header information in the image data of the original image 400 is analyzed to extract its Huffman table.

Subsequently, Huffman-encoded code data (more particularly, a byte sequence starting with an SOS marker) in the image data of the original image 400 is picked out, and code data before Huffman-encoding is extracted using the extracted Huffman table.

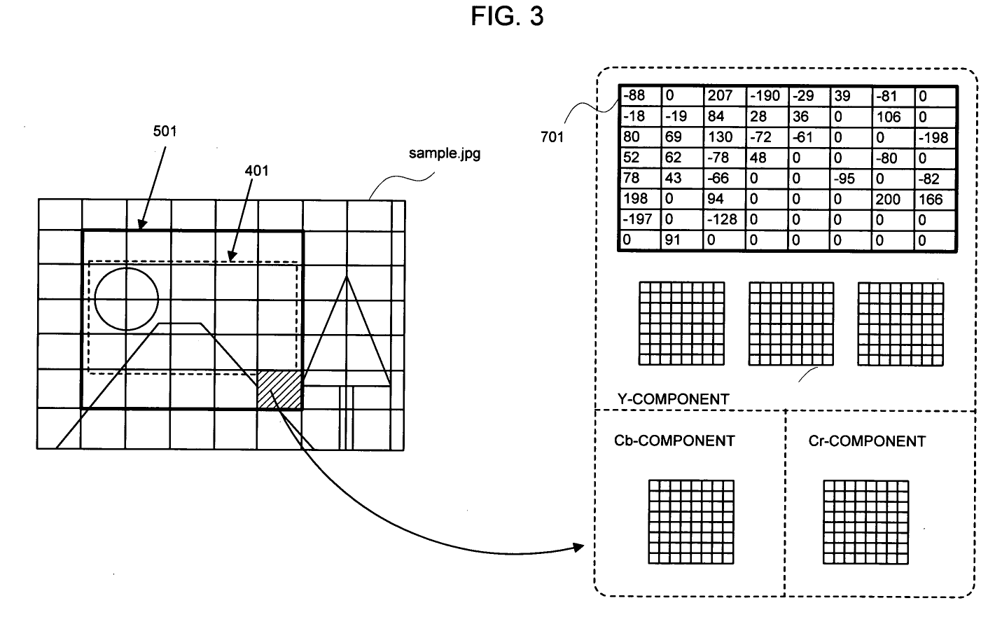

Finally, coefficient data corresponding to each one of the tiles (five by five tiles, i.e., a total of 25 tiles in the case of FIG. 2) present in the tile area 501 is extracted from the code data. The coefficient data for each tile is comprised of a plurality of eight-by-eight matrices, an example of which is shown in FIG. 3, containing four Y matrices, one Cb matrix, and one Cr matrix, for example.

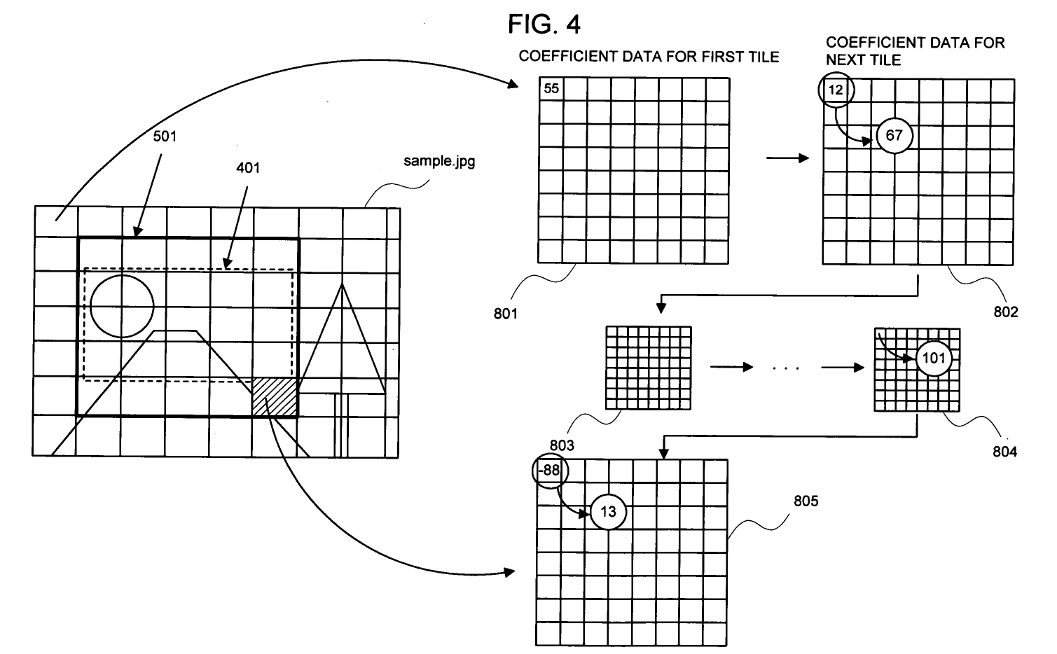

At this point, recalculation of a DC component is performed on each matrix of the coefficient data for each tile. As used herein, the term DC component refers to a coefficient at an upper-left corner in a matrix, while coefficients other than the DC component are referred to as AC components. A procedure for the recalculation of a DC component will be described hereinbelow with reference to FIG. 4.

First, for a coefficient (801 in FIG. 4) for a first tile in the image data of the original image 400, a DC component (55 for the data 801 in FIG. 4) is picked out; next, for a coefficient 802 for a next tile adjacent to the aforementioned tile, a DC component (12 for the data 802) is picked out; and the value of the DC component of the coefficient 801 and that of the coefficient 802 are added together. The resulting sum is then used as a new DC component for the coefficient 802. Therefore, the value of the DC component of the coefficient 802 becomes 67. That is, when the image data for the original image 400 is in a JPEG format containing a DC component representing a difference, an original value for the data is restored.

Thereafter, the aforementioned calculation is repeated in a similar way until a value of a DC component for a coefficient 805 of the last one of the target tiles in the tile area 501 is reached. In FIG. 4, the value of the DC component for the coefficient 805 is 13. Such calculation processing is performed on each of matrices contained in the coefficient data.

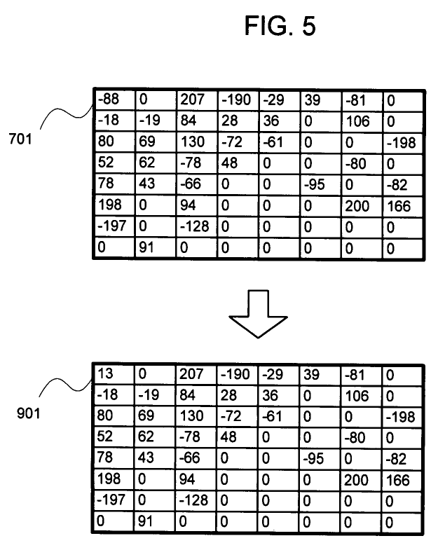

Moreover, Huffman encoding is performed on a combination of the calculated DC component value and corresponding AC components of the coefficient data (a result for the matrix 701 in FIG. 3 is shown in the matrix 901 in FIG. 5) using an extracted Huffman table according to a known technique.

The aforementioned processing is performed on coefficient data of all tiles contained in the tile area 501 to obtain Huffman-encoded data.

Image data of the image area 401 is thus obtained.

Next, a method of distributing such image data will be described hereinbelow, which method may be one of the following methods:

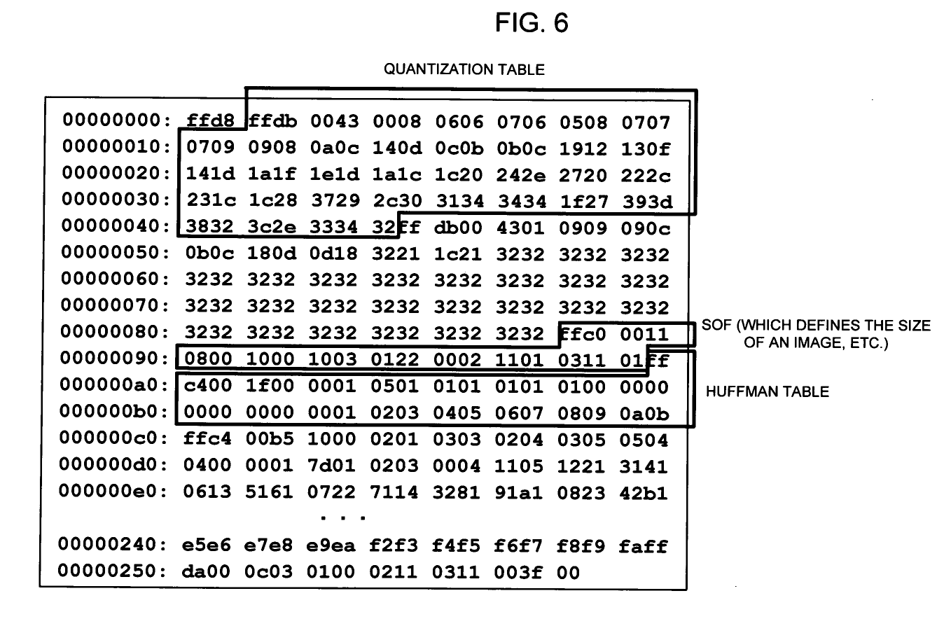

A first method distributes the image data as image data in a JPEG format, in which JPEG header information generated according to a known technique is appended to the Huffman-encoded data having a newly calculated DC component value. As used herein, JPEG header information contains information including the size of an image (in FIG. 4, 16×16, which is the size of a tile), a Huffman table, and a quantization table (which, in FIG. 4, has the JPEG header information for the image data of the original image 400 analyzed and extracted according to a known technique), an example of which is shown in FIG. 6. A more detailed specification is found in Recommendation ISO/IEC 10918-1:1994 for the aforementioned JPEG standard. The aforementioned processing is performed on Huffman-encoded data of tiles contained in the tile area 501.

A second method transmits the Huffman-encoded data having a newly calculated. DC component value to a requestor of distribution, and separately therefrom, transmits one piece of JPEG header information to the requestor of distribution. The requester of distribution appends the JPEG header to each piece of the distributed Huffman-encoded data, and performs decoding processing.

Now an explanation of particular embodiments of the invention described above will be given hereinbelow..

### Embodiment 1

An Embodiment 1 of the present invention will now be described.

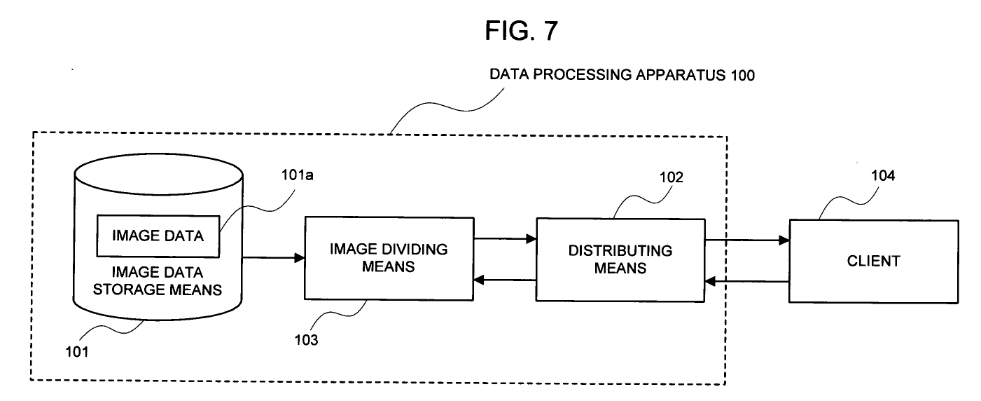

Referring to FIG. 7, The Embodiment 1 is comprised of a data processing apparatus 100 that is operated by program control, and a client 104 connected therewith via a network such as the Internet.

The data processing apparatus 100 comprises image data storage means 101 for storing image data 101a, distributing means 102 for conducting distribution of image data to the client 104, and image dividing means 103 for calculating coefficient data for a partial-area image from the image data 101a in response to a request from the client 104.

The image data storage means 101 is a storage in which image data 101a in a JPEG format to be distributed to the client 104 is stored, and for example, image data captured by a prevalent digital camera is stored.

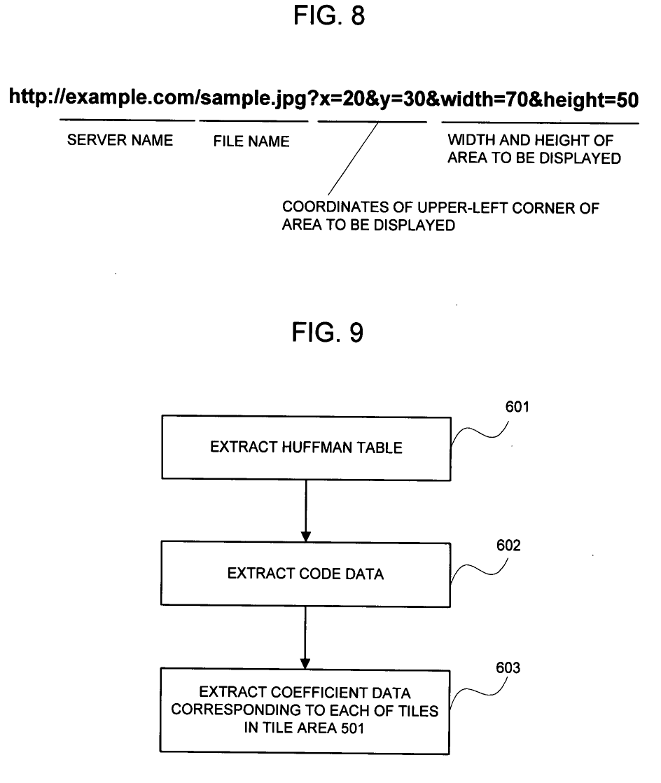

The client 104 passes image data for an image in an area to be displayed and area data for an area to be displayed, to the distributing means 102 as a request for distribution. For example, as shown in FIG. 8, it passes the name of a server that stores the requested image data, the name of an image data file, and an X-coordinate, a Y-coordinate, a width and a height at an upper-left corner of the area desired to be displayed, designated by URI (Uniform Resource Identifiers), to the distributing means 102 as a request. The following explanation will be made with reference to FIG. 1 as an example of the image data and image area 401 requested for distribution by URI shown in FIG. 8, and the image data and area data of FIG. 1 will be used in the following explanation.

The distributing means 102 next receives the request for distribution for the image data and area data from the client 104, extracts the file name of the image data to be displayed and the coordinates, width and height of the upper-left corner of the area to be displayed from the request for distribution, and passes them to the image dividing means 103 as image area information. For example, when a request for distribution as shown in FIG. 8 is received, a file name of the image data of “sample.jpg,” an X-coordinate of 20, a Y-coordinate of 30, a width of 70, and a height of 50 of the image area are passed to the image dividing means 103.

Next, the image dividing means 103 receives the file name of the image data and image area information from the distributing means 102, and determines a tile area containing the requested image area. As used herein, the term tile refers to a divided area obtained by partitioning the image data by 8m×8n pixels (where m, n designate a set of positive numbers defined by a JPEG standard; they are parameters determined in encoding image data in a JPEG format). The example of FIG. 2 described earlier is used in the following explanation as an example of tiles for the image data of FIG. 1 (where the image of FIG. 1 is encoded with m=2 and n=2, for example) and the tile area 501 containing the requested image area 401.

Next, an operation of the image dividing means 103 will be described with reference to a flow chart shown in FIG. 9.

The image dividing means 103 uses a known technique to pick out coefficient data for each of the tiles corresponding to the tile area 501 from image data 101a identified by the file name of image data received from the distributing means 102, from among image data stored in the image data storage means 101. Particularly, JPEG header information of the image data 101a is first analyzed to extract a Huffman table (Step 601 in FIG. 9).

Next, Huffman-encoded code data (more particularly, a byte sequence starting with an SOS marker) in the image data 101a is picked out, and code data before Huffman-encoding is extracted using the Huffman table (Step 602). Finally, coefficient data corresponding to each one of the tiles (five by five tiles, i.e., a total of 25 tiles in the case of FIG. 2) present in the tile area 501 is extracted from the code data (Step 603). The coefficient data for each tile is comprised of a plurality of eight-by-eight matrices, and when four Y matrices, one Cb matrix, and one Cr matrix are contained, for example, the data is that as shown in FIG. 3.

The image dividing means 103 performs recalculation of a DC component on each matrix of the coefficient data extracted as described above. As used herein, the term DC component refers to a coefficient at an upper-left corner in a matrix, while coefficients other than the DC component are referred to as AC components. A procedure for the recalculation of a DC component will be described hereinbelow with reference to FIG. 4. First, for coefficient data (801 in FIG. 4) for a first tile in the image data of the original image, a DC component (=55) is picked out; next, for coefficient data 802 for a next tile adjacent to the aforementioned tile, a DC component (=12) is picked out; and the value of the DC component of the coefficient data 801 and that of the coefficient data 802 are added together. A result of the addition is then data used as a DC component for the coefficient data 802. Therefore, the value of a DC component of the coefficient 802 becomes 67 (=55+12).

Thereafter, the aforementioned recalculation is repeated in a similar way until the last tile in the tile area 501 is reached, whereupon recalculation of a DC component for the coefficient 805 of the last tile is achieved. In FIG. 4, the DC component for the coefficient data 805 of the last tile is 13. Such recalculation processing is performed on each of matrices contained in the coefficient data.

Moreover, the image dividing means 103 performs Huffman encoding on a combination of the recalculated DC component value and corresponding AC components of the coefficient data (a result for the matrix 701 in FIG. 5 is shown in the matrix 901 in FIG. 5) using the Huffman table extracted at Step 601 in FIG. 9, according to a known technique. The aforementioned processing is performed on coefficient data of all tiles contained in the tile area 501, and the obtained Huffman-encoded data is passed to the distributing means 102.

Next, the distributing means 102 receives the Huffman-encoded data having the recalculated DC component value from the image dividing means 103, and distributes the data as image data in a JPEG format to the client 104, in which JPEG header information generated according to a known technique is appended to the Huffman-encoded data. As used herein, JPEG header information contains information including the size of an image (16×16, which is the size of a tile), Huffman table (extracted at Step 601 in FIG. 9), and a quantization table (which has the JPEG header information for the image data 101a analyzed and extracted according to a known technique), the header information being that as shown in FIG. 6 as described above.

The aforementioned processing is performed on the Huffman-encoded data of all tiles contained in the tile area 501.

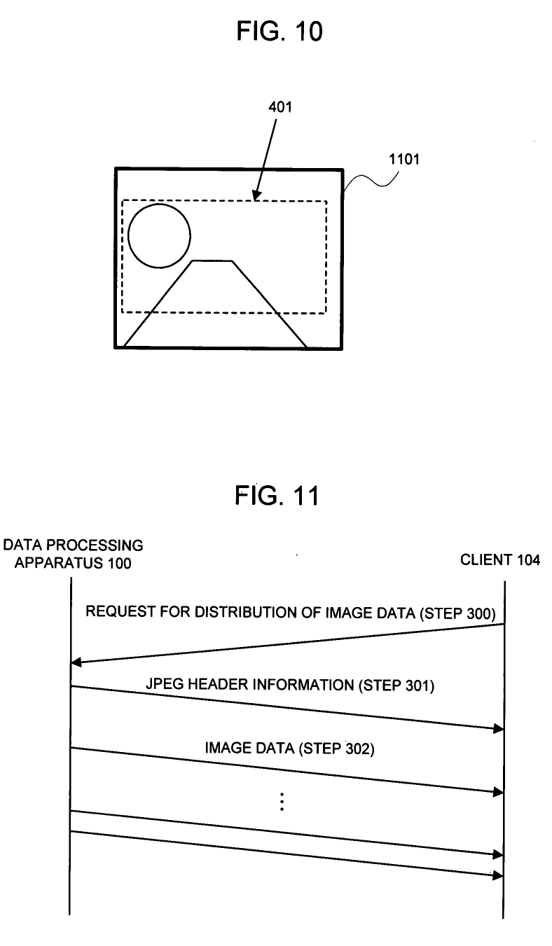

The client 104 receives the image data in a JPEG format for all tiles contained in the tile area 501 from the distributing means 102, decodes the image data, and displays them on a screen of the client, arranged side by side in a sequence of the tiles. An example of the result of display 1101 for the image area 401 requested for distribution by a client is shown in FIG. 10.

Since this embodiment is configured to implement clipping of a tile area only by an arithmetic operation (in particular, addition of the DC components) on coefficient data, there is provided an effect that distribution of a partial-area image containing an image area requested by a client 104 can be achieved by the data processing apparatus 100 without performing re-encoding of the image data.

Moreover, since this embodiment is configured to operate using image data in a JPEG format used in currently prevalent digital cameras or cell phones, there is provided an effect that an image captured by a digital camera can be used as image data 101a as is, or a cell phone can be easily used as the client 104.

Furthermore, although the image data in a JPEG format for tiles distributed by the distributing means 102 are arranged side by side and displayed as received, as described in the preceding explanation of the embodiment, only an area corresponding to the image area 401 requested for distribution by the client 104, rather than all the tiles, may be displayed. Thus, there is provided an effect that a partial-area image roughly the same as the image area requested for distribution can be displayed.

### Embodiment 2

Now an Embodiment 2 of the present invention will be described. It should be noted that since the calculation of new coefficient data for each tile, etc. in the Embodiment 2 are similar to those in the Embodiment 1, a detailed description of portions similar to those in the Embodiment 1 will be omitted in the following explanation.

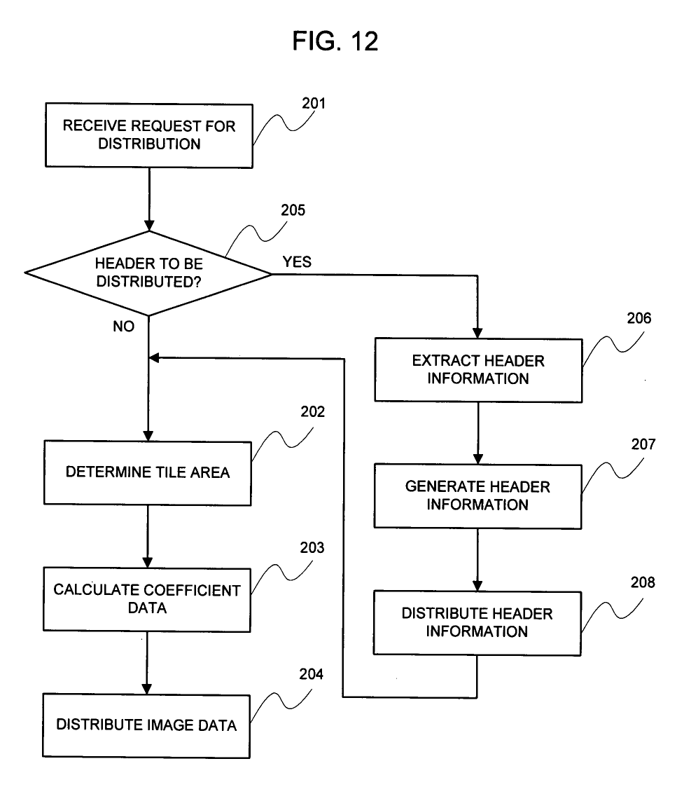

FIGS. 11 and 12 are flow charts of a distribution operation in the Embodiment 2. The operation of the Embodiment 2 will be described with reference to FIGS. 11 and 12 hereinbelow.

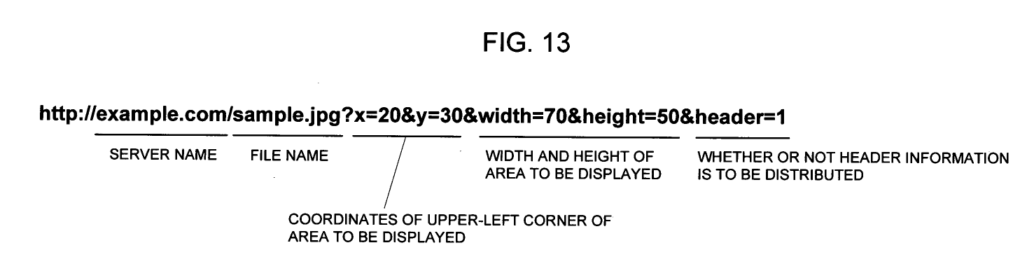

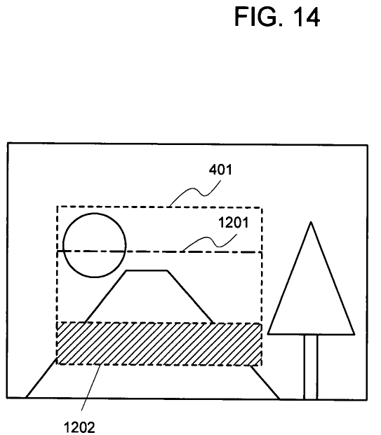

First, the client 104 passes image data to be displayed, area data, and whether or not JPEG header information is to be distributed, to the distributing means 102 as a request for distribution (Step 300 in FIG. 11). For example, as shown in FIG. 13, it passes the name of a server that stores requested image data, the file name of the image data, the X-coordinate, Y-coordinate, width and height of an upper-left corner of the area to be displayed, and whether or not the header information is to be distributed (if the value of the header is one, the information is to be distributed; otherwise, it is not to be distributed, or the like), which are designated by URI (Uniform Resource Identifiers), to the distributing means 102 as a request. The example shown in FIG. 1 is used as an example of the image data and image area 401 requested for distribution by the URI shown in FIG. 13, and the image data and area data of FIG. 1 will be used in the following explanation.

Next, the distributing means 102 receives the image data, area data, and request for distribution of header information from the client 104, and passes the file name of the image data to be displayed, the coordinates, width and height of the upper-left corner of the area to be displayed, and a request for distribution of header information, which are extracted from the request for distribution, to the image dividing means 103 as image area information (Step 201). For example, if a request for distribution as shown in FIG. 13 is received, a file name of the image data of “sample.jpg,” an X-coordinate of 20, a Y-coordinate of 30, a width of 70, and a height of 50 of the image area, and header information distribution being to be distributed are passed to the image dividing means 103.

Next, the image dividing means 103 receives the file name of the image data, image area information, and request for distribution of header information from the distributing means 102, and first checks whether the header information is to be distributed (Step 205).

If header information is not requested for distribution, the process goes to Step 202 for determination of a tile region.

If header information is requested for distribution, information such as the size of tiles, Huffman table, quantization table and the like are extracted from the image data 101a indicated by the file name for the image data received from the distributing means 102, from among image data stored in the image data storage means 101 using a known technique (Step 206). As used herein, the term tile refers to a divided area obtained by partitioning image data by 8m×8n pixels (where m, n designate a set of positive numbers defined by a JPEG standard; they are parameters determined in encoding image data in a JPEG format).

Next, JPEG header information is generated by a known technique (Step 207). As used herein, JPEG header information contains information including the size of an image, a Huffman table, and a quantization table, and the JPEG header information is generated using the size of tiles extracted from the image data 101a as the size of an image, and the Huffman table and quantization table extracted from the image data 101a as the Huffman table and quantization table. For example, an example of the generated JPEG header information is shown in FIG. 6.

Next, the image dividing means 103 passes the generated JPEG header information to the distributing means 102, which in turn distributes the JPEG header information to the client 104 (Steps 208, 301).

The image dividing means 103 determines a tile area containing the requested image area (Step 202). FIG. 2 shows tiles for image data of FIG. 1 (where the image of FIG. 4 is encoded with m=2 and n=2, for example) and a tile area 501 containing the requested image area 401.

Next, the distributing means 102 receives the Huffman-encoded data having the recalculated DC component value from the image dividing means, and distributes it to the client 104 as image data. The aforementioned processing is performed on the Huffman-encoded data of all tiles contained in the tile area 501.

Finally, the client 104 receives the Huffman-encoded data for all tiles contained in the tile area 501 from the distributing means 102 (Step 302), combines every piece of Huffman-encoded data with the JPEG header information distributed at Steps 208, 301 to obtain image data in a JPEG format, decodes the image data, and displays them on a screen of the client, arranged side by side in a sequence of the tiles. An example of the result of display 1101 for the image area 401 requested for distribution by a client is shown in FIG. 10.

According to the foregoing explanation of this embodiment, the client 104 is described as being able to specify whether header information is to be distributed in a request for distribution; however, since JPEG header information is identical for the same image, the distributed JPEG header information may be saved and specification may be made to prevent re-distribution of the header information when issuing a request for re-distribution of an image that has been requested for distribution once. This eliminates the necessity of receiving JPEG header information each time a request for distribution occurs, providing an effect that a connect time can be reduced because the amount of data to be distributed from the distributing means 102 to the client 104 can be reduced.

Moreover, while in the preceding description of this embodiment, image data of a JPEG format is obtained by combining every piece of Huffman-encoded data with the JPEG header information that has been distributed at Step 208, JPEG image data may be distributed by joining Huffman-encoded data for all tiles into a set of encoded data, which is then appended with the JPEG header information. In this case, the client 104 can perform ordinary decoding processing on a JPEG image except that the client 104 handles the data as if it were inserted with a restart marker (RSTm: which is for initializing a predicted value for a DC component; see Recommendation ISO/IEC 10918-1:1994 of a JPEG standard for further information) between pieces of encoded data of a pair of tiles, thereby achieving decoding and display of the distributed JPEG image data.

Although the client 104 is described as making a request for distribution of area data for an image to be displayed in the above-mentioned Embodiment 1 and Embodiment 2, if image data for part of the image area has been already distributed to the client 104, for example, in a case in which an image is scrolled for display, only a differential area may be requested for distribution. For example, as shown in FIG. 14, when a request for distribution of an image area 1201 is issued after a request for distribution of the image area 401 and scrolling of an image, a request for a difference 1202 may be issued to the distributing means 102. This provides an effect that the amount of data to be distributed and a load of recalculation processing for a DC component to be performed at the image dividing means 103 can be reduced.

### APPLICABILITY IN INDUSTRY

The present invention may be applied to usages such as an image data distributing apparatus for distributing image data in a JPEG format to a client, and a program for implementing the image distributing apparatus on a computer. Moreover, it may be applied to usages such as an image data display apparatus for displaying image data in a JPEG format stored as local data, and a program for implementing the image data display apparatus on a computer.

1. An image data generating method for generating image data for a predetermined image area of an original image, characterized in comprising:
selecting tiles corresponding to the predetermined image area from image data of the original image; and
generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

2. The image data generating method as recited in claim 1, characterized in that: the image has image data in a JPEG format.

3. The image data generating method as recited in claim 1 or claim 2, characterized in that: said generated coefficient data for each tile is appended with JPEG header information.

4. An image distributing method for, in response to a request for distribution of image data for a predetermined image area of an original image, distributing the image data of said predetermined image area, characterized in comprising:
selecting tiles corresponding to the image area requested for distribution from image data of the original image;
generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and
transmitting said generated coefficient data for each tile appended with JPEG header information, to the requestor of distribution.

5. An image distributing method for, in response to a request for distribution of image data for a predetermined image area of an original image, distributing the image data of said predetermined image area, characterized in comprising:
selecting tiles corresponding to the image area requested for distribution from image data of the original image;
generating, as coefficient data for each of the selected tiles, coefficient data whose DC component is a sum of a value of a DC component of the current tile and that of an immediately preceding tile adjacent to said tile in the original image and whose AC component is a value of an AC component in the original image;
distributing said generated coefficient data for each tile and JPEG header information separately; and
joining said JPEG header information and said coefficient data for each tile at a distributee to generate image data in a JPEG format.

6. An image data generating apparatus for generating image data for a predetermined image area of an original image, characterized in having:
means for selecting tiles corresponding to the predetermined image area from image data of the original image; and
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

7. The image data generating apparatus as recited in claim 6, characterized in that: the image has image data in a JPEG format.

8. An image distributing apparatus for, in response to a request for distribution of image data for a predetermined image area of an original image, distributing the image data of said predetermined image area, characterized in having:
means for selecting tiles corresponding to the image area requested for distribution from image data of the original image;
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and
means for transmitting said generated coefficient data for each tile appended with JPEG header information, to the requestor of distribution.

9. An image distributing apparatus for, in response to a request for distribution of image data for a predetermined image area of an original image, distributing the image data of said predetermined image area, characterized in having:
means for selecting tiles corresponding to the image area requested for distribution from image data of the original image;
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and
means for transmitting said generated coefficient data for each tile and JPEG header information separately to the requestor of distribution.

10. A program for an image data generating apparatus for generating image data for a predetermined image area of an original image,
said program characterized in causing said image data generating apparatus to function as:
means for selecting tiles corresponding to the predetermined image area from image data of the original image; and
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image.

11. The program for the image data generating apparatus as recited in claim 10, characterized in that: the image has image data in a JPEG format.

12. A program for an image distributing apparatus for, in response to a request for distribution of image data for a predetermined image area of an original image, distributing the image data of said predetermined image area,
said program characterized in causing said image distributing apparatus to function as:
means for selecting tiles corresponding to the image area requested for distribution from image data of the original image;
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and
means for transmitting said generated coefficient data appended with JPEG header information, to the requestor of distribution.

13. A program for an image distributing apparatus for, in response to a request for distribution of image data for a predetermined image area of an original image, distributing the image data of said predetermined image area,
said program characterized in causing said image distributing apparatus to function as:
means for selecting tiles corresponding to the image area requested for distribution from image data of the original image;
means for generating, as coefficient data for each of the selected tiles, coefficient data whose DC component is a sum of a value of a DC component of the current tile and that of an immediately preceding tile adjacent to said tile in the original image and whose AC component is a value of an AC component in the original image; and
means for transmitting said generated coefficient data and JPEG header information separately to the requestor of distribution.
